(19) United States
(12) Patent Application Publication
(10) Pub. No.: US 2014/0095504 A1
(43) Pub. Date: Apr. 3, 2014

(54) SYSTEMS AND METHODS FOR CATALOGING USER-GENERATED CONTENT

(71) Applicant: Kourosh Soroushian, San Diego, CA (US)

(72) Inventor: Kourosh Soroushian, San Diego, CA (US)

(73) Assignee: UNITED VIDEO PROPERTIES, INC., Santa Clara, CA (US)

(21) Appl. No.: 13/631,330

(22) Filed: Sep. 28, 2012

(51) Int. Cl. G06F 17/30

(52) U.S. Cl. CPC G06F 17/30115
USPC 707/737

(57) ABSTRACT

Systems and methods are described herein for cataloging user-generated content. In one embodiment, user-generated content is received, and metadata associated with the user-generated content may be captured. The metadata may be automatically analyzed to determine one or more common characteristics of the user generated content. For example, it may be determined that the user-generated content was recorded during a trip along a particular route, or during a period where the user was exhibiting stressful physiological signs. Groupings of user-generated content may be defined based on the common characteristics. Post-processing and file storage operations may be performed on the user-generated content associated with a grouping. Groupings may be selected for playback and the user-generated content may be streamed to a target device.

### BACKGROUND OF THE INVENTION

The availability of high internet speeds, large cloud storage, the integration of multimedia recording capabilities in mobile devices, and the widespread adoption of social networks has lead to a rise in the creation of user-generated content. This user-generated content may allow a user to qualitatively or quantitatively measure aspects of a person's daily life in terms of inputs (e.g., food consumed, quality of surrounding air, sights seen), states (e.g., mood, arousal, blood oxygen levels) and performance (e.g., mental and physical).

Due to the high volume of user-generated content (e.g., recordings lasting for hours or days), it is not practical to expect manual tagging and cataloging of content by individuals, such that the content can be easily processed or viewed (i.e., played back) after recording. Also, the cataloging of the user-generated content may require processing capabilities that are not possible on the device used to capture the user-generated content itself.

### SUMMARY OF THE INVENTION

Systems and methods are described herein for an automated process for cataloging and playing back user-generated content. In one embodiment, a processing server may receive files of user-generated content. As used herein, “user-generated content” refers to audio recordings, video recordings, still images, or audiovisual recordings that are captured by a personal recording device that is worn or operated by a user. For example, a processing server may receive files associated with two or more videos recorded on a cell phone operated by a user. A set of metadata associated with the at least two files of user-generated content may be captured. As used herein, “metadata” refers to data that directly or indirectly describes circumstances associated with the recording of the user-generated content, the user's physical state at the time the user-generated content was recorded, or the user's emotional state at the time the user-generated content was recorded. This metadata may be embedded along with the audio and video information associated with the user-generated content in a synchronized manner, or recorded separately (e.g., on a device separate from the device used to record the user-generated content) and time-stamped such that they may maintain synchronization with the content. For example, the processing server may extract metadata from the user-generated content that indicates that the user-generated content was recorded at particular geo-locations. The metadata may be automatically analyzed to identify at least one common characteristic. For example, the geo-locations associated with the videos may be analyzed without user input to determine that three of the videos were recorded along a physical route to and from the user's workplace.

Groupings of the files of the user-generated content may be defined based on the common characteristic. For example, videos may be grouped based on the fact that the routes on which they were recorded were scenic (as compared to frequent drives to and from a workplace in a major city). A post-processing or file storage operation may be performed on the user-generated content in the groupings. In one example, a grouping of videos recorded on a drive to or from a user's workplace may be processed such that their audio is removed. This processing may reduce the size of the videos or remove information from the videos that the user does not want to preserve (e.g., conference calls conducted on a drive to or from the user's workplace). In another example, a file storage operation may be performed on a grouping of videos recorded on a drive to or from a user's workplace such that the user-generated content in the grouping are stored in a common folder. These file storage operations may conveniently organize the user-generated content such that they are easier to access for later viewing (i.e., playback).

A selection of one of the groupings of the user-generated content for playback may be received. The user-generated content in the selected grouping may then be played back. This selection may allow the user to easily view the user-generated content related to circumstances associated with the user-generated content (e.g., videos recorded during a scenic drive to a vacation cabin), mood of the user associated with the time period that the user-generated content was recorded (e.g., videos recorded when the user was happy or excited), physical state of the user when the user-generated content was recorded (e.g., videos recorded when the user had an elevated heart rate), or some combination of these factors. In addition, because the playback feature is related to the groupings, the user is able to easily pinpoint which user-generated content he or she wants to play back among what could be hundreds or thousands of files of user-generated content.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 illustrates an example of a cross-platform interactive media system in accordance with some embodiments of the present disclosure;

FIG. 5 shows an illustrative implementation of a system for cataloging user-generated content in accordance with some embodiments of the present disclosure;

FIG. 6 shows an illustrative screen for cataloging user-generated content in accordance with some embodiments of the present disclosure;

FIG. 7 shows another illustrative screen for cataloging user-generated content in accordance with some embodiments of the present disclosure;

FIG. 8 shows an illustrative screen for post-processing user-generated content in accordance with some embodiments of the present disclosure;

FIG. 9 shows an illustrative screen for selecting groupings of user-generated content for playback in accordance with some embodiments of the present disclosure;

FIG. 10 shows an illustrative metadata structure in accordance with some embodiments of the present disclosure;

FIG. 11A shows another illustrative flowchart for cataloging user-generated content in accordance with some embodiments of the present disclosure;

FIG. 11B shows another illustrative flowchart for cataloging user-generated content in accordance with some embodiments of the present disclosure; and

FIG. 11C shows yet another illustrative flowchart for cataloging user-generated content in accordance with some embodiments of the present disclosure.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

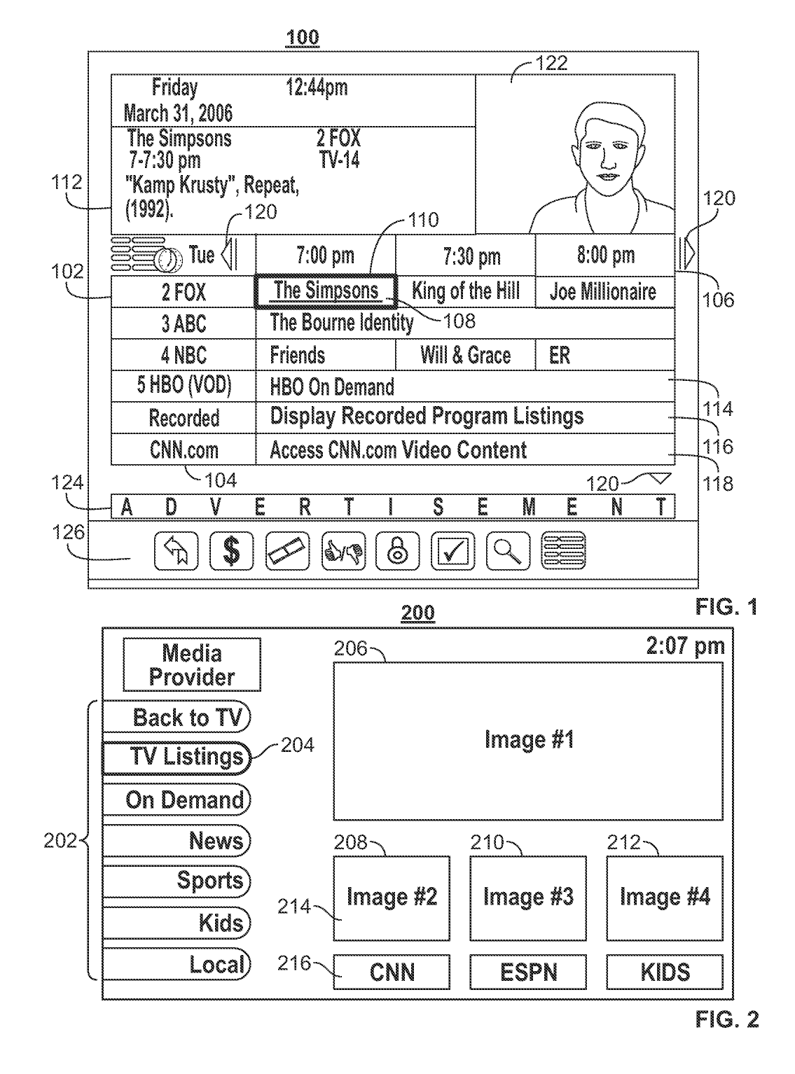

FIGS. 1-2 show illustrative display screens that may be used to provide media guidance data. The display screens shown in FIGS. 1-2 and 6-9 may be implemented on any suitable user equipment device or platform. While the displays of FIGS. 1-2 and 6-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

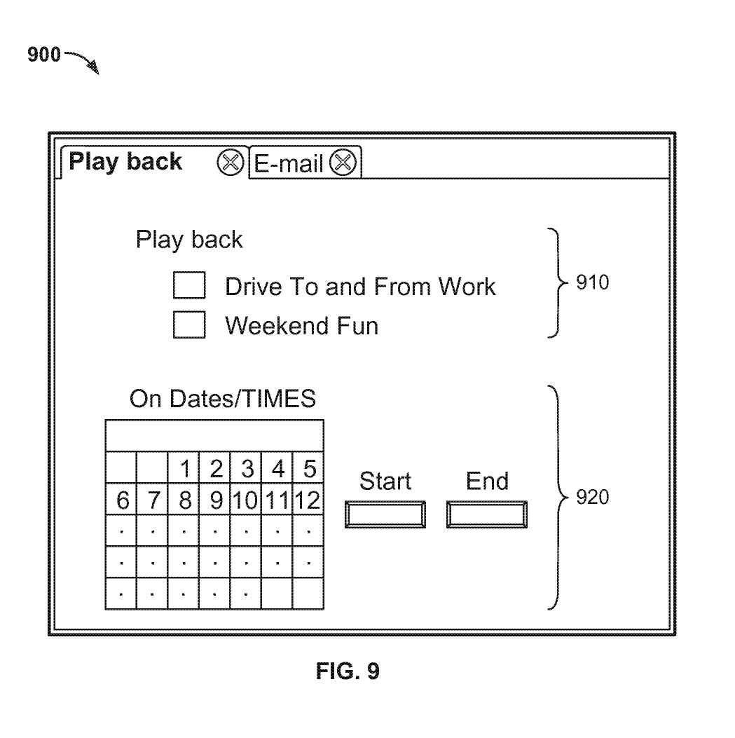

Display 100 may also include video region 122, advertisement 124, and options region 126. Video region 122 may allow the user to view and/or preview programs or user-generated content that is currently available, will be available, or were available to the user. The content of video region 122 may correspond to, or be independent from, one of the listings displayed in grid 102, or one of the selected groupings of display 900 (discussed below with respect to FIG. 9). Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

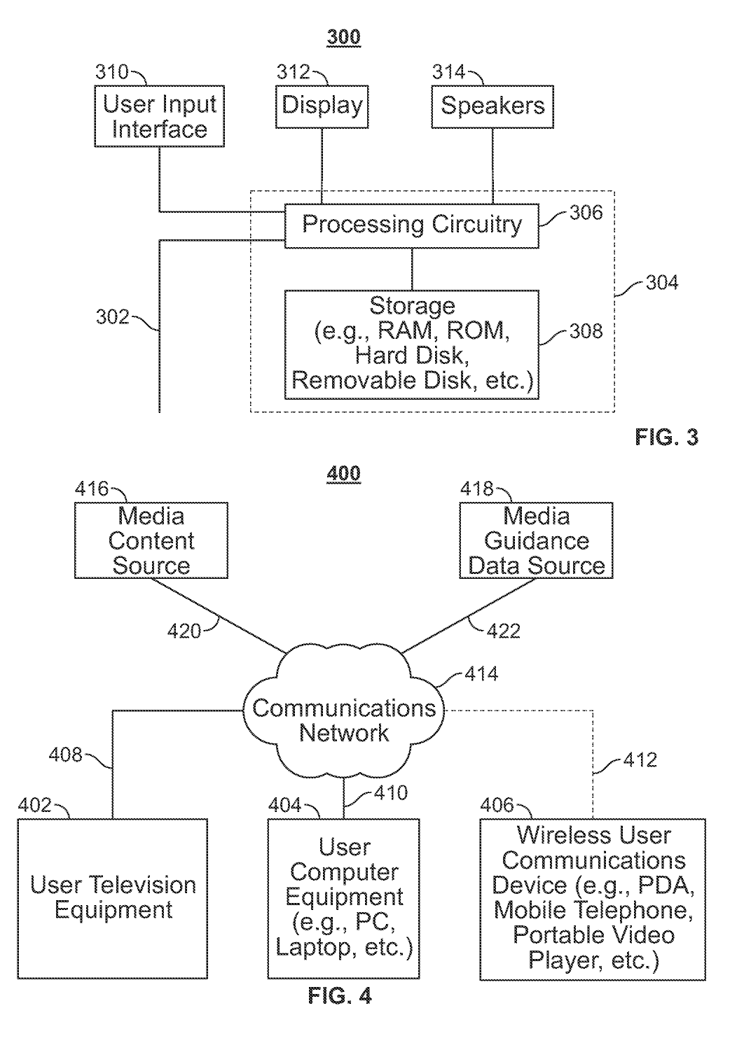

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

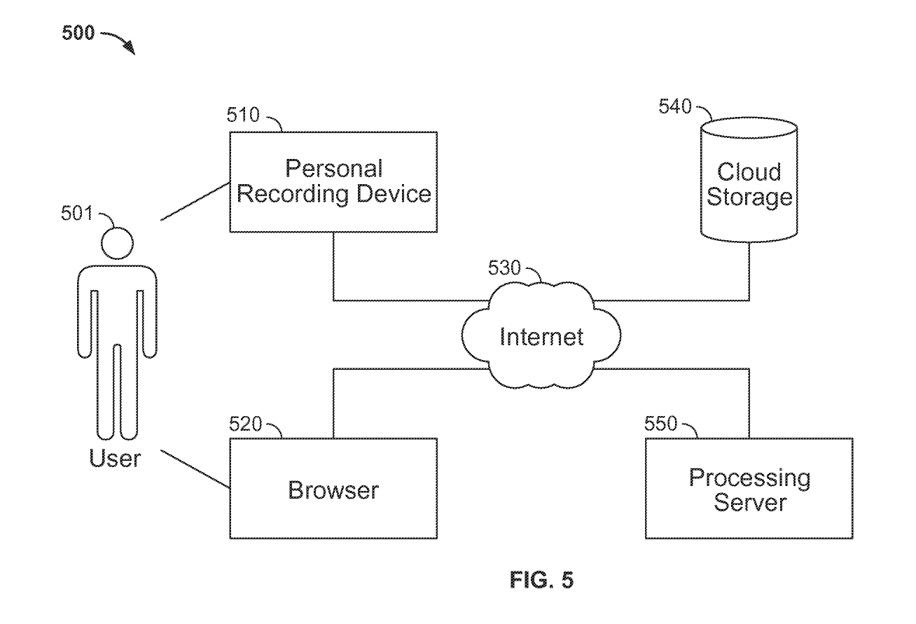

FIG. 5 shows an illustrative implementation of a system 500 for cataloging user-generated content in accordance with some embodiments of the present disclosure. System 500 includes user 501, who may wear and/or control personal recording device 510. Personal recording device 510 may be any suitable device to record audio, video, still images, or some combination of the three to create user-generated content. In certain embodiments, personal recording device 510 may be worn by the user. For example, personal video recording device 510 may be a wearable device that includes a head-mounted camera such as Google's Project Glass, the GoPro Hero 2, or any suitable wearable device for recording audio, video, still pictures, or some combination of the three. In other embodiments, personal recording device 510 may be any suitable mobile device such as a PDA, smartphone, laptop, or tablet.

In some embodiments, personal recording device 510 may include one or more biological sensors (not illustrated) that capture information about the mood of or physiological measurements associated with user 501. These biological sensors may include any suitable biological sensors for measuring one or more of heartrate, movement (e.g., amount of steps taken or amount of distance travelled), calories burned, breathing patterns, weight, blood pressure, or voice tone of user 510. In some embodiments, metadata associated with these measurements may be captured in any suitable data format and embedded in the files associated with the audio, video, or still pictures recorded by personal recording device 510 in a synchronized manner. For example, a time stamp may be recorded by the biological sensors and synchronized with the time base of the audio, video, or still pictures recorded by personal recording device 510. Alternatively, metadata associated with these biological measurements may be stored in separate files from the files associated with the audio, video, or still pictures captured by the personal recording device 510, and synchronized separately (e.g., at processing server 550, discussed below). In certain embodiments, these biological sensors may be integrated into personal recording device 510. In other embodiments, these biological sensors may be physically separate from personal recording device 510. For example, these biological sensors may be collected in a casing separate from personal recording device 510, such as a Fitbit Ultra manufactured by Fitbit Inc.

Personal recording device 510 may transmit the captured audio, video, still pictures, and/or biological data via internet 530 to one or more of cloud storage 540 and processing server 550. Cloud storage 540 may be any combination of hardware and software suitable to provide one or more cloud-based services as part of a cloud computing environment as discussed with respect to system 400 of FIG. 4. In some embodiments, personal recording device 510 may stream the audio, video, still pictures and/or biological data it captures to cloud storage 540 in real-time (i.e., as soon as individual files of audio, frames or fields of video, or still pictures are recorded) via a mobile connection to internet 530 (e.g., via wifi, Bluetooth, 3G, 4G, 4G LTE, or any suitable mobile data connection). In other embodiments, personal recording device 510 may upload the audio, video, still pictures, or biological data it captures to cloud storage 540 over a wired connection to Internet 530 directly from personal recording device 510 or via an intermediate user equipment device such as a personal computer, laptop, or tablet computer.

Processing server 550 may be any suitable combination of hardware and software suitable for streaming media and cataloging audio, video, and still pictures captured by personal recording device 510. For example, processing server 550 may be any suitable PC server or Linux server with redundant data storage. In some embodiments, processing server 550 may receive a stream of usergenerated content and metadata from personal recording device 510 via any suitable wired or wireless connection to internet 530. In other embodiments, processing server 550 may periodically request data from personal recording device 510 via any suitable wired or wireless connection to internet 530.

In certain embodiments, processing server 550 may be accessed remotely by user 501 via any suitable user interface. These user interfaces may allow the user to express his preferences in recording and cataloging the user-generated content recorded by personal recording device 510, storing the user-generated content on processing server 550 or cloud storage 540, or streaming playback of the user-generated content on a target device via internet 530, or some combination of the three. In certain embodiments, the target device may be a user equipment device 300 (FIG. 3) capable of running browser 520. Browser 520 may be any web browser suitable for displaying setting screens and streaming playback of the user-generated content. User 501 may interact with browser 520 using any suitable user input interface 310 (FIG. 3). In some embodiments, browser 520 may be implemented on personal recording device 510 itself (i.e., personal recording device 510 and user equipment device 300 are the same). In other embodiments, browser 510 may be implemented on a user equipment device 300 that is separate from personal recording device 510.

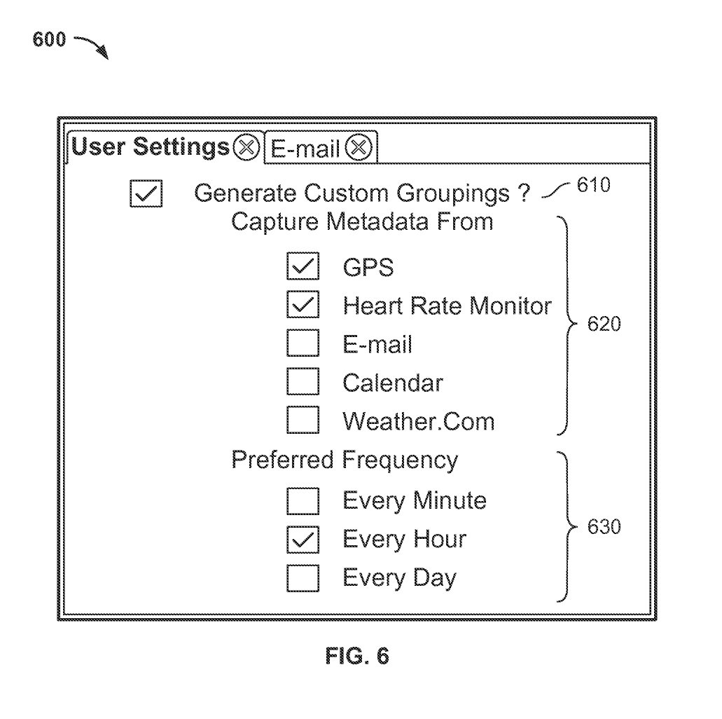

FIGS. 6-9, discussed below, show illustrative screens that allow a user to express his preferences in recording and cataloging the user-generated content, storing the user-generated content, or streaming playback of the user-generated content. In some embodiments, as illustrated, these screens may be rendered by browser 530 (FIG. 5) based on data generated by processing server 560 and streamed over internet 530. In other embodiments (not shown), these screens may be rendered directly by the software of processing server 560.

FIG. 6 shows an illustrative screen 600 for cataloging user-generated content in accordance with some embodiments of the present disclosure. Screen 600 includes custom groupings option 610. When custom groupings option 610 is selected, received files of user-generated content may be grouped (i.e., cataloged or categorized) according to one or more common characteristics of the user-generated content. In some embodiments, these common characteristics may be determined based on metadata associated with the files of user-generated content. As discussed with respect to system 500 (FIG. 5), this metadata may be captured by one or more biological sensors integrated with, or separate from, personal recording device 510. For example, a heart rate monitor worn by the user may generate information that is captured in metadata and stored with the user-generated content. In certain embodiments, this metadata may be captured from data sources external to personal recording device 520 or processing server 560. These external data sources may be associated with electronic accounts maintained by a user. In one example, appointments gathered from a user's electronic calendar service or subject field and sender information gathered from a user's e-mail service, social networks, or both may be captured from those respective services in metadata and stored with the user-generated content. In one example, DVD rental history may be gathered from the user's account associated with a DVD rental service, such as Netflix. In another example, information associated with multimedia shared by or with a user on a social network, such as Facebook or Twitter, may be gathered. This information may include updates to social networks such as, for example, Facebook timeline posts, Twitter updates, and personal or direct messages between users. In some embodiments, the external data sources may be unrelated to the user. For example, data may be gathered from a weather service to capture metadata associated with the temperatures.

Screen 600 may include metadata capture options 620. Metadata capture options 620 may contain one or more data sources that the user may select from in order to capture metadata associated with user-generated content. In certain embodiments, more than one of the metadata capture options 620 may be selected at a time. In certain embodiments, metadata capture options 620 may include one or more options to capture data from sensors integrated into or physically separate from personal recording device 520 (FIG. 5). For example, as shown in screen 600, metadata capture options 620 may include options to capture metadata from a GPS, a heart rate monitor, or both. In some embodiments, these sensors may include biological sensors discussed with respect to system 500. In certain embodiments, metadata capture options 620 may include options to capture data from external data sources associated with electronic accounts associated with the user, or unrelated to the user, as discussed above.

Screen 600 may also include frequency options 630. Frequency options 630 specify the frequency with which metadata should be captured from the sources selected in metadata capture options 620. This frequency may be of any suitable granularity, such as minutes, hours, days, weeks, or months. The sources selected in metadata capture options 620 may be polled based on the selected frequency options 630. For example, as illustrated, metadata from a GPS and heart rate monitor may be captured every hour as specified by metadata capture options 620 and selected frequency options 630.

In some embodiments, the amount and kind of frequency options 630 may change based on which metadata capture options 620 are selected. In one example, when “E-mail” is selected under metadata capture options 620, frequency options 630 may change to display options for selecting a length of time, time period, and/or a frequency that metadata associated with a user's e-mail account should be captured (e.g., the next five hours, between 10 and 11 AM every day, or every Friday between 8 AM and 6 PM). In another example not illustrated in screen 700, when “Twitter” is selected under metadata capture options 620, frequency options 630 may change to display options for selecting a period of time or frequency that metadata associated with a user's Twitter feed (e.g., follower feed, interactions, or direct messages) should be captured.

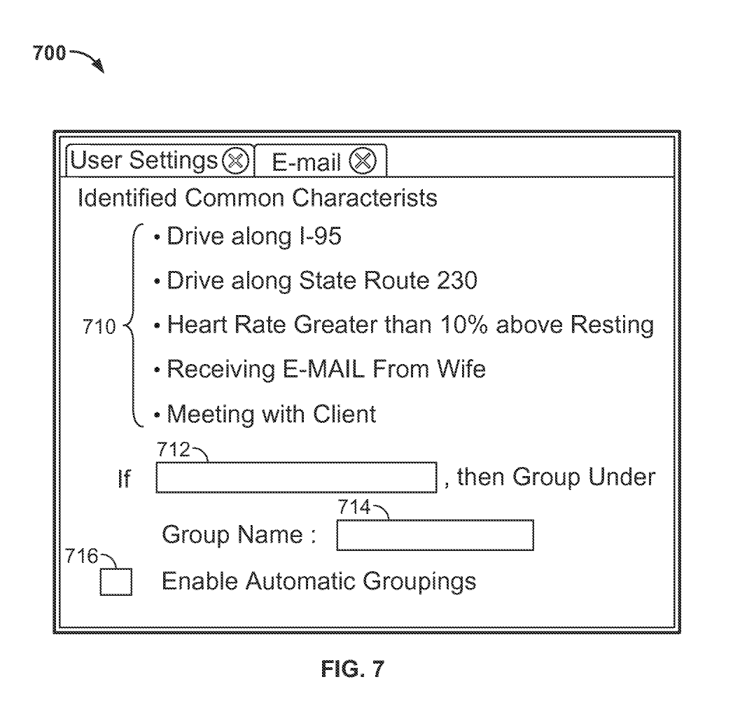

FIG. 7 shows another illustrative screen 700 for cataloging user-generated content in accordance with some embodiments of the present disclosure. Screen 700 may include common characteristics 710. Common characteristics 710 may be characteristics that are shared between more than one piece of user-generated content that have been determined from analysis of captured metadata associated with the files of user-generated content. This analysis is performed automatically (e.g., without user input) by the software and hardware that performs the cataloging of the user generated content, such as processing server 550 (FIG. 5). In certain embodiments, common characteristics 710 may be based on comparing captured metadata to data from an external source of data. In one example, captured metadata that includes geo-location information associated with where user-generated content was recorded may be automatically analyzed to determine that the geo-locations are along the same highway, road, or route between two points. This common characteristic may be listed as “Drive along 1-95” or “Drive along state route 230,” as illustrated.

In other embodiments, common characteristics 710 may be based on comparing captured metadata to data input by a user. This user input may be related to, for example, health information associated with a user. For example, a user may be prompted to enter his age, weight, and height. This user input may then be used to determine the user's optimal resting heart rate. Captured metadata associated with information from a heart rate monitor worn by the user may then be compared to the optimal resting heart rate, and automatically analyzed to determine one or more thresholds at which the user's heart rate was above the optimal resting heart rate. This common characteristic may be listed as “Heart rate greater than 10% above resting,” as illustrated.

In yet other embodiments, common characteristics 710 may be based on comparing captured metadata to a combination of data input by a user and data from one or more external sources of data. In one example, a user may be prompted to enter the name of e-mail senders that he or she enjoys receiving e-mail from, such as a spouse or partner. Captured metadata associated with the “sender” field in an e-mail may be compared to this input to determine whether the user has received e-mail from the sender during the metadata capture period. Metadata associated with all senders of e-mail to the user may be automatically analyzed to determine frequent senders of e-mail to the user as compared to the volume of e-mail a user receives. If a sender is above a certain frequency threshold (e.g., one out of every ten e-mails is from a particular sender), e-mail received from a sender may be determined to be a common characteristic. This common characteristic may be displayed as “receiving e-mail from wife,” as illustrated. In certain embodiments, the above-mentioned example may be applied to any suitable e-mail field, such as the subject line or message body, in order to determine frequent topics of interest or discussed subject matter that the user designates as important to cross-index with user-generated content. In certain embodiments, similar functionality may be achieved with other methods of communication, such as voice chats, text messages, instant messages, Tweets, Facebook timeline posts, or any suitable communications.

In another example, electronic calendar appointments associated with a user may be automatically analyzed together with user input to determine a common characteristic. A user may be prompted to enter the name of a party that he or she is usually nervous to meet with. Captured metadata associated with the fields of the user's electronic calendar appointments may be automatically analyzed to determine which of these parties the user frequently meets with. If a party that the user designates is met with frequently, appointments with the party may be determined to be a common characteristic. This common characteristic may be displayed as “meeting with client,” as illustrated.

Screen 700 may also include grouping option box 712. In certain embodiments, a user may drag and drop one or more common characteristics 710 using any suitable input device (e.g., user input interface 310 (FIG. 3)) into grouping box 712. The user-generated content associated with the common characteristics that are placed into grouping option box 710 may then be associated with a grouping that is specified in group name box 714. In some embodiments, the grouping of user-generated content associated with the selected common characteristics 710 may be defined by additional metadata, such as a tag with the name specified in group name box 714. This additional metadata may be embedded within the user-generated content itself, or stored in a data structure separate from the user-generated content.

Screen 700 may also include automatic grouping option 716. When automatic grouping option 716 is selected, common characteristics 710 may be selected to define a grouping automatically based on predetermined criteria. In certain embodiments, these criteria may include similarity between the types of metadata underlying common characteristics 710. For example, if one or more common characteristics were derived from the same type of metadata, such as metadata generated from geo-location information, a grouping may be defined that includes the user-generated content associated with those common characteristics.

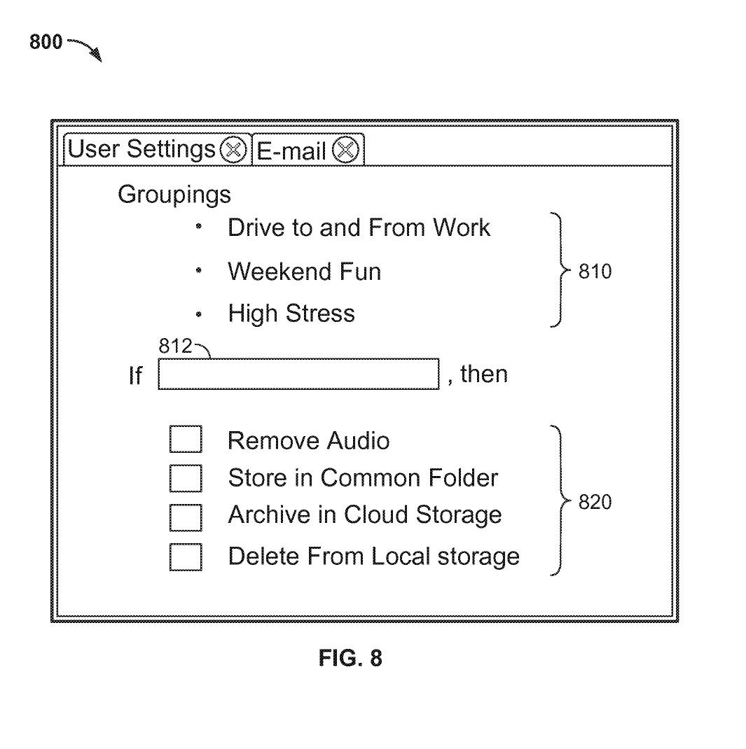

FIG. 8 shows an illustrative screen 800 for post-processing user-generated content in accordance with some embodiments of the present disclosure. Screen 800 may include one more groupings 810. Groupings 810 may be the same as those group names specified by the user in group name box 714 in screen 700 (FIG. 7), or may be automatically generated according to pre-determined criteria associated with automatic grouping option 716. For example, the grouping “Drive to and from work” may be specified by the user to describe user-generated content that share the common characteristic of being recorded during a user's drive to and from their workplace as determined from geo-location information collected from a GPS. In another example, the grouping “weekend fun” may be specified by the user to describe user-generated content that share the common characteristic of being recorded during the drive to, from, and during a user's weekend retreat in the mountains as determined from geo-location information collected from a GPS. In yet another example, the grouping “high stress” may be specified by the user to describe user-generated content that share common characteristics associated with high stress situations, such as user-generated content recorded during the time that e-mail was received from a boss, as well as user-generated content that was recorded when the user's heart rate was 10% above the user's resting heart rate.

Screen 800 includes grouping selection box 812. A user may drag and drop one or more groupings 810 to grouping selection box 812 in order to apply one or more post-processing or file storage operations to the user-generated content associated with the selected groupings. Post-processing and file storage options 820 specify which operations will be applied to the user-generated content associated with groupings 810 that are selected and placed in grouping selection box 812. In certain embodiments, post-processing and file storage options 820 may include an option to remove audio from the user-generated content. Such embodiments may be useful to reduce the size of user-generated content in which audio is not of particular importance to a user, or to censor user-generated content in which the audio contains sensitive information (e.g., a user may want to remove audio from the user-generated recordings associated with his drive to and from work, because he often conducts confidential business calls in his car during those drives).

In certain embodiments, post-processing and file storage options 820 may include an option to store the user-generated content in a common file folder. If this option is selected, a folder in file system of the storage of processing server 550 (FIG. 5) may be created, and the user-generated content associated with the common characteristics of a grouping may be stored in the folder. In certain embodiments, post-processing and file storage options 820 may include an option to archive the user-generated content associated with the common characteristics of a grouping in cloud storage, such as cloud storage 540. In yet other embodiments, post-processing and file storage options 820 may include an option to archive the user-generated content associated with the common characteristic of a grouping in local storage, such as storage within processing server 550 or personal recording device 510. In yet other embodiments, post-processing and file storage options 820 may include an option to delete the user-generated content associated with the common characteristics from local storage, cloud storage, or both.

FIG. 9 shows an illustrative screen 900 for selecting groupings of user-generated content for playback in accordance with some embodiments of the present disclosure. Screen 900 may include one or more user selectable groupings 910 which the user can select to playback. Groupings 910 may correspond to groupings 810 of screen 800 (FIG. 8). Screen 900 may also include date and time options 920 which allow the user to specify a time or range of times (e.g., a range of days, or range of times within one or more days) associated with time stamps or a time base within the user-generated content of a grouping selected from groupings 910 which the user wants to play back.

In some embodiments, each of the files of user-generated content associated with a grouping selected from groupings 910 may be queued for play back in a determined order (e.g., a playlist). The order may be based on a sorting according to one or more of the length of the user-generated content (e.g., shorter user-generated content are played before longer user-generated content within a grouping), a user specified rating of the user-generated content (e.g., higher rated user-generated content is played before lower rated user-generated content within a grouping), or the time and date on which the user-generated content was recorded (e.g., later recorded user-generated content is played before earlier recorded user-generated content within a grouping).

In certain embodiments, the user-generated content within the groupings selected to be played back may be streamed from storage within one or more of cloud storage 540 and storage of processing server 550 to a target device. The target device may be any suitable interface, such as browser 550, on any suitable hardware, such as a laptop, mobile phone, tablet computer, or any suitable user equipment device 300 (FIG. 3).

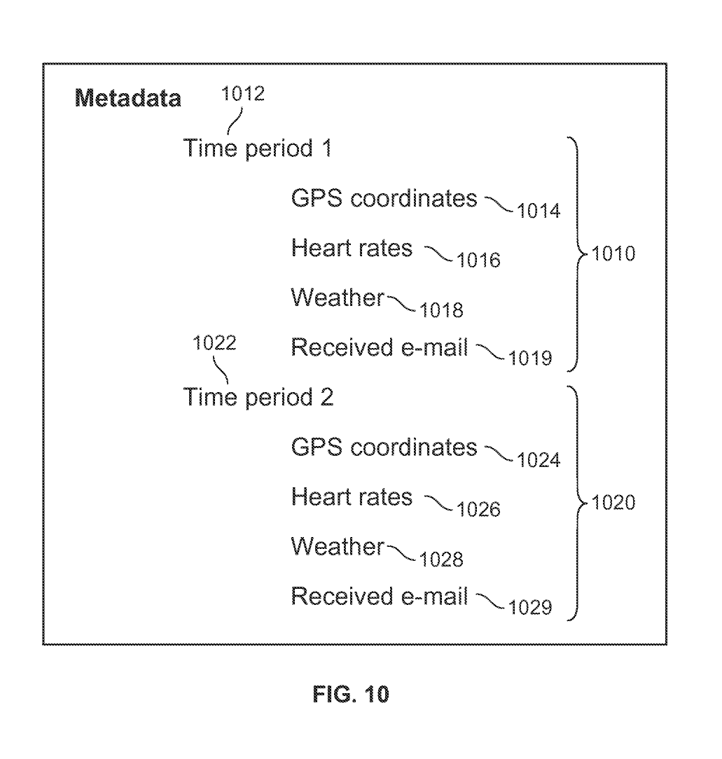

FIG. 10 shows an illustrative metadata structure, including first metadata set 1010 and second metadata set 1020, in accordance with some embodiments of the present disclosure. First metadata set 1010 and second metadata set 1020 may be metadata that are associated with, or integrated into, files of user-generated content. In certain embodiments, first metadata set 1010 and second metadata set 1020 may be headers 1012 and 1022 that convey the time period that the metadata in the set covers. In certain embodiments, this time period may be expressed in a time base that matches the time base of one or more files of user-generated content. In such embodiments, this feature may allow for easy synchronization or integration of the set of metadata with the files of user-generated content. In other embodiments, this time period may be expressed as a time base that is separate from the time base of one or more files of user-generated content. In such embodiments, the time period expressed by headers 1012 and 1022 may be synchronized with one or more files of user-generated content. In certain embodiments, first metadata set 1010 and second metadata set 1020 may include the same types of metadata. In other embodiments, first metadata set 1010 and second metadata set 1020 may include one or more different types of metadata. In certain embodiments, first metadata set 1010 and second metadata set 1020 may be stored on one or more of the storage of processing server 550 or cloud storage 540 (FIG. 5). It is understood that first metadata set 1010 and second metadata set 1020 are only two examples of sets of metadata, and that many more permutations or combinations of sets of metadata are possible.

In certain embodiments, first metadata set 1010 and second metadata set 1020 may include GPS coordinates 1014 and 1024, heart rates 1016 and 1026, weather information 1018 and 1028, and e-mail information 1019 and 1029. GPS coordinates 1014 and 1024 may include a list of geo-locations expressed by longitudinal and latitudinal coordinates. Heart rates 1016 and 1026 may include a list of heart rates expressed in beats per minute. Weather information 1018 and 1028 may include one or more temperatures, pollen counts, precipitation levels, or any suitable weather information. Received e-mail 1019 and 1029 may include information from one or more e-mail fields, such as the sender, recipients, subject line, or e-mail body. In some embodiments (not shown), first metadata set 1010 and second metadata set 1020 may include information from one or more fields of social media communications, such as data associated with Twitter updates, Facebook timeline posts, private or direct messages, or any suitable social media communications. Each of the entries in these types of metadata may be marked with times that are within the range of times conveyed by the time periods in headers 1012 and 1022. In one example, GPS coordinates 1014 and 1024 may express longitudinal and latitudinal coordinates collected by GPS circuitry according to any suitable interval, such as every second, 5 seconds, 30 seconds, 1 minute, or any suitable interval.

In certain embodiments, first metadata set 1010 and second metadata set 1020 may include information gathered from social networks. For example, one or more files of user-generated content may be tagged in a social network with one or more of a location, other entities (e.g., people or pets) at that location, and information about the activities at that location (e.g., a caption or description). In certain embodiments, processing server 550 (FIG. 5) may prompt the user for security credentials associated with a social network, authenticate itself with the social network using those credentials, and poll the social network for metadata associated with the user-generated content at any suitable interview. For example, processing server 550 may prompt a user for their Facebook login credentials, authenticate itself with Facebook using those credentials, and poll those portions of Facebook's application programming interfaces associated with its photo and video sharing capabilities for any suitable metadata described above.

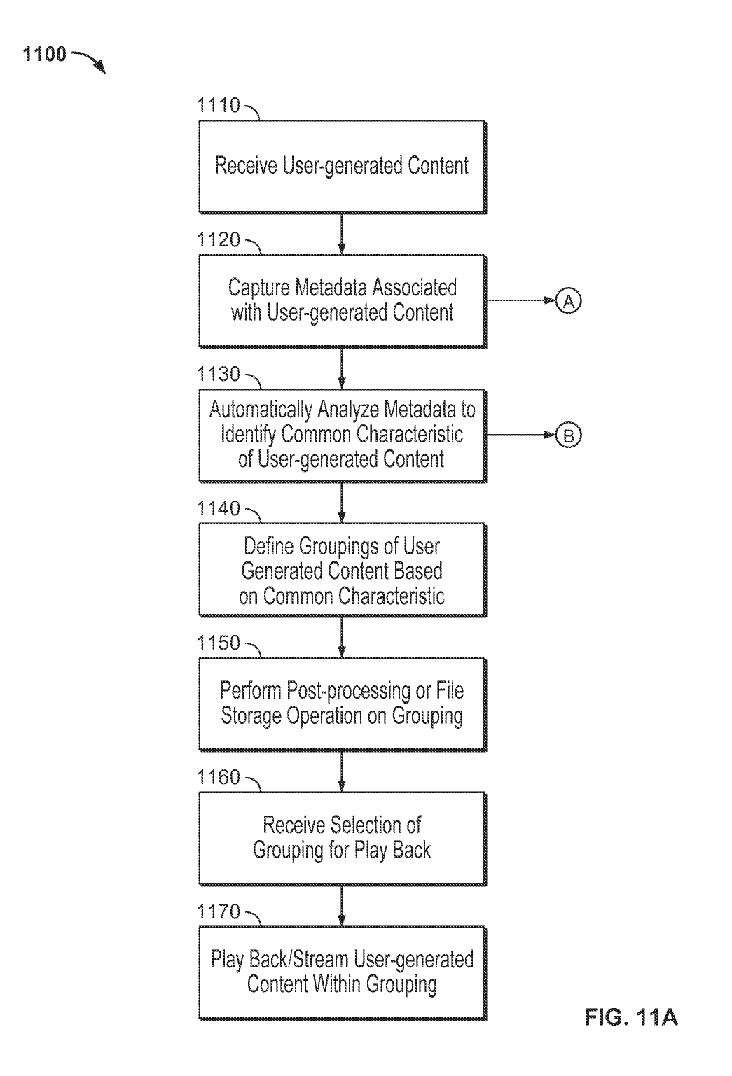

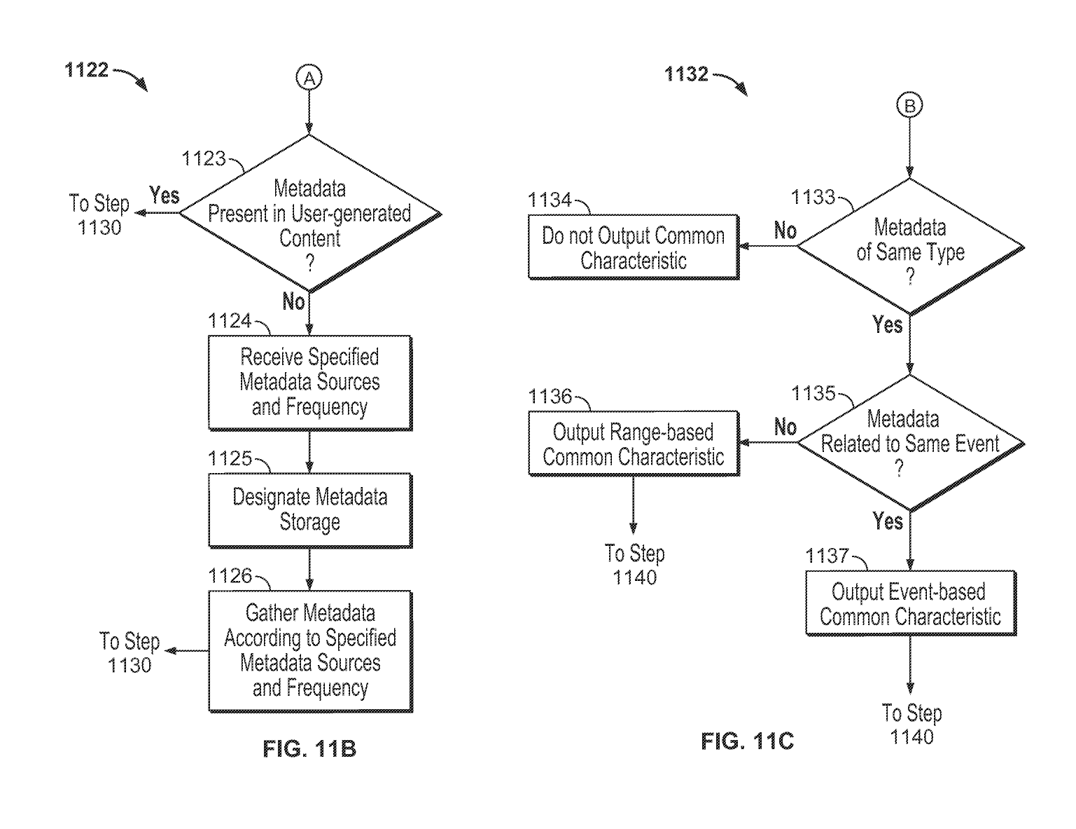

FIG. 11A shows another illustrative flowchart of a process 1100 for cataloging user-generated content in accordance with some embodiments of the present disclosure. In certain embodiments, one or more of the steps of process 1100 may be performed by processing server 550 (FIG. 5). In other embodiments, one or more of the steps of process 1100 may be performed by personal recording device 510 (FIG. 5). In certain embodiments, one or more of the steps of process 1100 may be executed automatically (e.g., without user input) by the software and hardware of personal recording device 510 or processing server 550.

At step 1110, user-generated content is received. This user-generated content may be one or more files associated with audio, video, or still pictures captured by a device that is worn or controlled by a user, such as personal recording device 510. In some embodiments, the user-generated content may be received as a stream of information that is pushed to processing server 550. In other embodiments, processing server 550 may request the files of user-generated content via a request to personal recording device 510. Process 1100 proceeds to step 1120.

At step 1120, metadata associated with the user-generated content is captured. This metadata may be captured from one or more of circuitry or sensors integrated within or in communication with personal recording device 510, such as GPS circuitry integrated within a mobile phone, or a heart rate monitor worn by the user and in communication with a mobile phone. In addition or alternatively, this metadata may be captured by querying external sources of information, such as a database of weather information. In certain embodiments, these external sources of information may be associated with online accounts associated with a user, such as a user's electronic calendar service, e-mail account, or video rental service. The sources of information from which the metadata is captured and the frequency of metadata that is captured may be specified by the user as described with respect to screen 600 (FIG. 6). In certain embodiments, the information captured from these sources may be parsed and stored in a standard format, such as the format described with respect to first metadata set 1010 and second metadata set 1020. In certain embodiments, the captured metadata may be embedded within the received files of user-generated content itself. In other embodiments, the captured metadata may be separately maintained from the received files of user-generated content. Process 1100 proceeds to step 1130.

At step 1130, the metadata may be automatically analyzed to identify a common characteristic of the user-generated content. This analysis may be carried out as described with respect to common characteristics 710 (FIG. 7). The metadata may be analyzed by comparing the metadata to an external source of data (e.g., comparing geo-locations to a map of commonly traveled roads or highways to determine that one or more files of user-generated content was recorded during a drive or hike along a particular route or to a particular location), data input by a user (e.g., using a user's height and weight to calculate an average heart rate, and then comparing heart rate measurements to the average heart rate to determine that user-generated content was recorded during a period where the user had an above-average heart rate), or both (e.g., prompting the user to name e-mail contacts they enjoy corresponding with, and comparing the frequency that e-mail is received from those contacts to this input to determine that user-generated content was recorded during a period where the user was having frequent conversations with such contacts). In certain embodiments, the common characteristics may be displayed to the user as depicted in screen 700 (FIG. 7). Process 1100 proceeds to step 1140.

At step 1140, groupings of the user-generated content are defined based on the common characteristics. In certain embodiments, the groupings may be defined based on the user selecting the common characteristics for a grouping, and then naming that grouping, as described with respect to grouping box 712 and group name box 714. In other embodiments, the groupings may be defined automatically without user input, as described with respect to automatic grouping option 716. In certain embodiments, the defined groupings may generate a tag that may be integrated into, or stored separately from, the files of received user-generated content. Process 1100 proceeds to step 1150.

At step 1150, a post-processing or file storage operation may be performed on the grouping. In certain embodiments, a post-processing operation may be performed on the files of user-generated content associated with the grouping. For example, files of user-generated content associated with a car ride may be compressed to save storage space. In certain embodiments, the post-processing operation may include removing audio from the files of user-generated content. Such post-processing may be useful where the user wishes to remove audio from user-generated content that is unimportant or that he or she does not wish to preserve. In certain embodiments, the file storage operation may organize the files of user-generated content associated with the grouping. For example, a folder may be created in a file system associated with the name of a grouping, and the files of the user-generated content associated with that grouping may be stored in the folder. In certain embodiments, the file storage operation may include storing or deleting the files of user-generated content associated with a grouping one or more of cloud storage (such as cloud storage 540) or local storage (such as the storage of processing server 550). In certain embodiments, the user may select which groupings he wishes to perform a post-processing or file storage operation on, and what post-processing or file storage operations will be performed, as illustrated on screen 800 (FIG. 8). Process 1100 proceeds to step 1160.

At step 1160, groupings of user-generated content may be selected for playback. This selection may be performed by the user through an interface as described with respect to screen 900 (FIG. 9). In certain embodiments, one or more of the files of user-generated content associated with a grouping may be queued for playback in a determined order (e.g., a playlist) as described with respect to groupings 910. Process 1100 proceeds to step 1170. At step 1170, user-generated content within the grouping may be played back or streamed. In certain embodiments, the playback may include one, several, or all of the files of user-generated content associated with the grouping. In certain embodiments, this streaming may be provided by processing server 550 to a target device, such as personal recording device 510 (FIG. 5). In certain embodiments, the stream may be viewed in a browser, such as browser 520. Process 1100 then ends.

FIG. 11B shows another illustrative flowchart of a process 1122 for cataloging user-generated content in accordance with some embodiments of the present disclosure. Process 1122 begins at step 1123. At step 1123, it is determined whether there is metadata present in the received files of user-generated content. For example, metadata may be embedded in the audio or video tracks of files of user-generated content. If metadata is already present in the files of user-generated content, no additional metadata may be gathered, and process 1122 proceeds to step 1130. Otherwise, process 1122 proceeds to step 1124.

At step 1124, specified metadata sources and frequency of metadata collection are received. In certain embodiments, the metadata sources and frequency of metadata collection may be specified by the user as described with respect to screen 600 (FIG. 6). Process 1122 proceeds to step 1125. At step 1125, storage locations for the metadata may be designated. In certain embodiments, the user may be presented with one or more options to store (i.e., embed) the gathered metadata in the files of user-generated content, or store the gathered metadata separately from the files of user-generated content. In certain embodiments, these options may allow the user to store the metadata in cloud storage (for example, cloud storage 540), or store the metadata in local storage (for example, the storage of processing server 550). Process 1122 then proceeds to step 1126.

At step 1126, metadata is gathered according to the metadata sources and frequency of collection specified at step 1124. In certain embodiments, gathering the metadata may require retrieving data from external data sources, such as an e-mail service, electronic calendar service, weather service, video rental service, or any suitable external data source. In such embodiments, the user may be prompted to provide their login credentials for services that require authentication (e.g., e-mail or an electronic calendar). The gathered metadata is then stored according to the metadata storage options designated at step 1125. Process 1122 then proceeds to step 1130 (FIG. 11A).

FIG. 11C shows yet another illustrative flowchart of a process 1132 for cataloging user-generated content in accordance with some embodiments of the present disclosure. Process 1132 begins at step 1133. At step 1133, it is determined whether the metadata associated with one or more received files of user-generated data is of the same type. In certain embodiments, this determination may be based on the header of the metadata. For example, the metadata may contain a header that conveys that the metadata are GPS coordinates, e-mail headers, weather information, or any other suitable type of metadata. In certain embodiments, this determination may be made based on whether the metadata itself is of a similar format. For example, metadata associated with GPS coordinates may have the same structure (e.g., precision of digits, or size of the data structure associated with the metadata). If the metadata associated with one or more received files of user-generated data is not determined to be the same type, process 1132 proceeds to 1134, and no common characteristic is output. For example, no common characteristic associated with the one or more received files of user-generated data may be presented to the user as illustrated in screen 700 (FIG. 7). Otherwise, process 1132 proceeds to step 1135.

At step 1135, it is determined whether the metadata associated with one or more received files of user-generated content is related to the same event. In certain embodiments, this determination may be made based on the metadata being associated with a common physical route or location. In one example, metadata conveying GPS coordinates may be analyzed using any algorithm to determine that the coordinates are clustered in the same location (such as a state park), or along a physical route on a map (such as a highway). Such groups of GPS coordinates may be designated as an event. When it is determined that metadata associated with one or more received files of user-generated content is related to the same event, process 1132 proceeds to step 1137. At step 1137, event-based common characteristics are output. For example, the common characteristic for GPS coordinates clustered in Golden Gate Park may be output as “walk in Golden Gate Park,” and the common characteristic for GPS coordinates along Highway 101 may be output as “drive along Highway 101.” Process 1132 may proceed to step 1140 (FIG. 11A).

If it is not determined that metadata associated with one or more received files of user-generated content is related to the same event, process 1132 proceeds to step 1136. At step 1136, range-based common characteristics are output. These common characteristics may be determined based on whether individual entries in the metadata are within a similar range. In one example, metadata conveying heart rates may be analyzed using any suitable algorithm to determine the heart rates are over 10% above a user's average heart rate. The common characteristic for such a range may be output as “elevated heart rate”. Process 1132 may proceed to step 1140 (FIG. 11A). At steps 1136 and 1137, the common characteristics may be presented to the user as illustrated in screen 700 (FIG. 7).

It will be apparent to those or ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for cataloging user-generated content, comprising:
receiving at least two files of user-generated content;
capturing a set of metadata associated with the at least two files of user-generated content;
automatically analyzing the set of metadata to identify at least one common characteristic of the at least two files of user-generated content;
defining groupings of the at least two files of user-generated content based on the at least one common characteristic;
performing at least one of a post-processing and file storage operation on the at least two files of user-generated content that are in one of the groupings;
receiving a selection of one of the groupings for playback; and
playing the at least two files of user-generated content that are in the selected grouping.

2. The method of claim 1, further comprising gathering at least one of geo-location or weather information associated with a time that the user-generated content was recorded, wherein the metadata comprises at least one of geo-location information or weather information.

3. The method of claim 2, wherein automatically analyzing the metadata to identify at least one common characteristic comprises determining a route based on the gathered geo-location information.

4. The method of claim 1, further comprising capturing physiological and mental attributes of a user at a time that the user-generated content was recorded from at least one biological sensor, wherein the metadata comprises the physiological and mental attributes.

5. The method of claim 4, wherein automatically analyzing the metadata to identify at least one common characteristic comprises determining a threshold heart rate based on the captured physiological attributes.

6. The method of claim 1, further comprising gathering communications received by a user at the time that the user-generated content was recorded, wherein the metadata comprises one or more fields of the received communications.

7. The method of claim 6, wherein automatically analyzing the metadata to identify at least one common characteristic comprises determining a frequent sender of communications based on the fields of the received communications.

8. The method of claim 1, wherein the post-processing operation comprises removing audio from the at least two files of user-generated content that are in one of the groupings.

9. The method of claim 1, wherein the file storage operation further comprises:
creating a folder in a file system associated with the at least one common characteristic of a grouping of the at least two files of user-generated content; and
storing the at least two files of user-generated content in the grouping in the folder.

10. The method of claim 1, further comprising:
transferring a first subset of the least two files of user-generated content and the captured set of metadata to cloud storage; and
storing a second subset of the at least two files of user-generated content and the captured set of metadata on local storage.

11. A system for cataloging user-generated content, comprising a processing server configured to:
receive at least two files of user-generated content;
capture a set of metadata associated with the at least two files of user-generated content;
automatically analyze the set of metadata to identify at least one common characteristic of the at least two files of user-generated content;
define groupings of the at least two files of user-generated content based on the at least one common characteristic;
perform at least one of a post-processing and file storage operation on the at least two files of user-generated content that are in one of the groupings;
receive a selection of one of the groupings for playback; and
stream playback of the at least two files of user-generated content that are in the selected grouping.

12. The system of claim 11, wherein the processing server is further configured to gather at least one of geo-location or weather information associated with a time that the user-generated content was recorded, wherein the metadata comprises at least one of geo-location information or weather information.

13. The system of claim 12, wherein the processing server is configured to automatically analyze the metadata to identify at least one common characteristic comprises by determining a route based on the gathered geo-location information.

14. The system of claim 11, wherein the processing server is further configured to capture physiological and mental attributes of a user at a time that the user-generated content was recorded from at least one biological sensor, wherein the metadata comprises the physiological and mental attributes.

15. The system of claim 14, wherein the processing server is further configured to automatically analyzing the metadata to identify at least one common characteristic by determining a threshold heart rate based on the captured physiological attributes.

16. The system of claim 11, wherein the processing server is further configured to gather communications received by a user at the time that the user-generated content was recorded, wherein the metadata comprises one or more message of the received communications.

17. The system of claim 16, wherein the processing server is configured to automatically analyzing the metadata to identify at least one common characteristic by determining a frequent sender of communications based on the fields of the received communications.

18. The system of claim 11, wherein the processing server is further configured to perform a post-processing operation by removing audio from the at least two files of user-generated content that are in one of the groupings.

19. The system of claim 11, wherein the processing server is further configured to perform a file storage operation by:
creating a folder in a file system associated with the at least one common characteristic of a grouping of the at least two files of user-generated content; and
storing the at least two files of user-generated content in the grouping in the folder.

20. The system of claim 11, wherein the system further comprises cloud storage and local storage, and wherein the processing server is further configured to:
transfer a first subset of the least two files of user-generated content and the captured set of metadata to cloud storage; and
store a second subset of the at least two files of user-generated content and the captured set of metadata on local storage.

21-30. (canceled)
